(19) United States
(12) Patent Application Publication
(10) Pub. No.: US 2025/0148847 A1
(43) Pub. Date: May 8, 2025

(54) VEHICLE CONTROL SYSTEM

(71) Applicant: TOYOTA JIDOSHA KABUSHIKI KAISHA, Toyota-shi (JP)

(72) Inventor: Shinya Yamasaki, Toyota-shi (JP)

(73) Assignee: TOYOTA JIDOSHA KABUSHIKI KAISHA, Toyota-shi (JP)

(21) Appl. No.: 18/911,267

(22) Filed: Oct. 10, 2024

(30) Foreign Application Priority Data
Nov. 6, 2023 (JP) 2023-189338

(51) Int. Cl. G07C 5/08; B60L 58/12; G07C 5/00

(52) U.S. Cl. CPC G07C 5/0825; B60L 58/12; G07C 5/008; B60L 2250/16; B60L 2260/54

(57) ABSTRACT

A vehicle control system for providing a remote operation service for remotely operating a device mounted on a vehicle by using a terminal located outside the vehicle, wherein the vehicle includes a service control unit that stops the remote operation service when power consumption of the in-vehicle battery exceeds a threshold when power generation cannot be performed, and the terminal includes a display control unit that displays, on a display screen, a reason why the remote operation service is unavailable when the remote operation service is stopped in the vehicle.

### CROSS-REFERENCE TO RELATED APPLICATION

This application claims priority to Japanese Patent Application No. 2023-189338 filed on Nov. 6, 2023, incorporated herein by reference in its entirety.

### BACKGROUND

### 1. Technical Field

The present disclosure relates to vehicle control systems that provide a remote operation service for allowing to remotely operate a device mounted on a vehicle by using a mobile terminal etc. located outside the vehicle.

### 2. Description of Related Art

WO 2013/124990 discloses a system that can remotely operate a device mounted on a vehicle (remote operation service) by sending, to the vehicle, operation commands input by a user to a terminal located outside the vehicle.

### SUMMARY

In order to prevent a battery mounted on a vehicle from running out, a predetermined limit is set for the amount of electric power that can be consumed from this in-vehicle battery when the vehicle is not in a state of being able to generate electric power (when the vehicle is not generating electric power). Therefore, the remote operation service needs to be stopped when such power consumption of the in-vehicle battery is high. However, if the user is not notified of the reason why the vehicle has stopped the remote operation service, he or she may feel inconvenience regarding not being able to use the remote operation service.

The present disclosure provides a vehicle control system that can notify a user of the reason why a remote operation service is stopped in a vehicle via a terminal located outside the vehicle.

One aspect of the technique of the present disclosure is a vehicle control system that provides a remote operation service for remotely operating a device mounted on a vehicle by using a terminal located outside the vehicle.

The vehicle includes a service control unit configured to stop the remote operation service in response to an amount of power consumption of an in-vehicle battery exceeding a threshold when the vehicle is unable to generate electric power.

The terminal includes a display control unit configured to, when the remote operation service is stopped in the vehicle, display on a display screen a reason why the remote operation service is unavailable.

According to the vehicle control system of the present disclosure, when the remote operation service is stopped in response to the amount of power consumption of the in-vehicle battery exceeding the threshold when the vehicle is not in a state of being able to generate electric power, the vehicle control system can notify the user of the reason why the remote operation service is unavailable through the screen display of the terminal located outside the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle control system according to an embodiment of the present disclosure;

FIG. 2 is a flowchart illustrating a processing procedure of display control executed by the vehicle control system;

FIG. 3 shows an example of the information displayed on the terminal located outside the vehicle; and

FIG. 4 is an example of information displayed on a screen of a terminal located outside the vehicle.

### DETAILED DESCRIPTION OF EMBODIMENTS

When a vehicle control system according to the present disclosure stops a remote operation service in response to the amount of power consumption of an in-vehicle battery exceeding a threshold when a vehicle is in a state of not generating electric power, the vehicle control system notifies a user through a screen display of a terminal located outside the vehicle that the remote operation service is unavailable due to high power consumption of the vehicle.

Hereinafter, an embodiment of the present disclosure will be described in detail with reference to the drawings.

### Embodiment

### Configuration

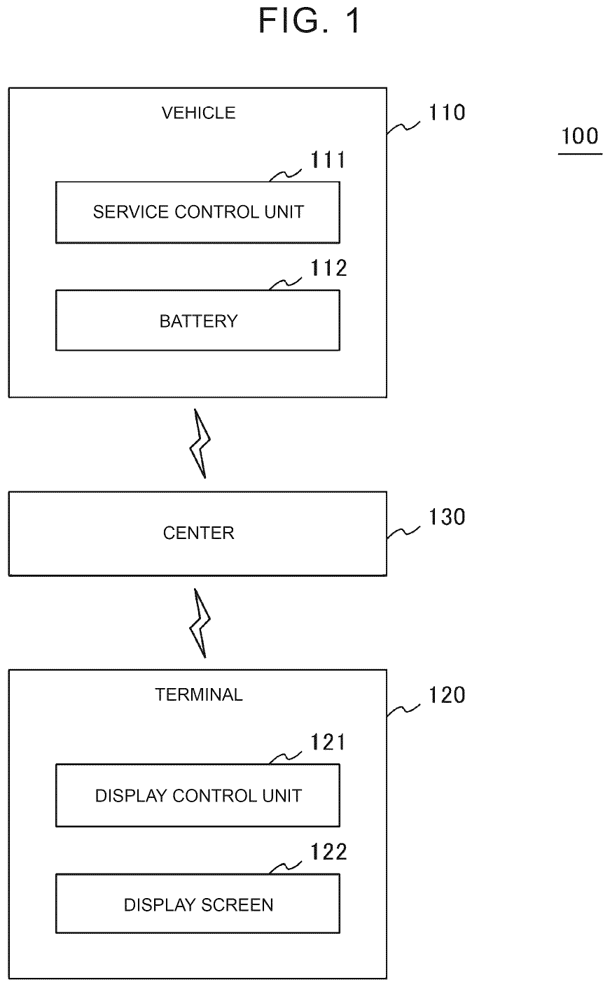

FIG. 1 is a schematic diagram illustrating an overall configuration of a vehicle control system 100 according to an embodiment of the present disclosure. The vehicle control system 100 illustrated in FIG. 1 includes a vehicle 110, a terminal 120, and a center 130.

### Vehicle

The vehicle 110 is a vehicle such as a battery electric vehicle (BEV) or a hybrid electric vehicle (HEV) equipped with a battery 112 that supplies electric power to one or more devices (in-vehicle devices) mounted on the vehicle 110.

The vehicle 110 has a function to implement a “remote operation service” that allows to remotely operate a specific in-vehicle device in the vehicle 110 from the terminal 120 located outside the vehicle.

Further, the vehicle 110 includes a service control unit 111 that can control the state of execution (permission) and stop (prohibition) of the remote operation service based on the power generation state of the vehicle 110 and the amount of power consumption of the battery 112. The vehicle 110 is communicably connected to the center 130, and performs transmission and reception of information, notifications, requests, and the like with the center 130. In addition, the vehicle 110 can notify the center 130 of the state of execution (permission)/stop (prohibition) of the remote operation service controlled by the service control unit 111. In particular, when the remote operation service is stopped due to a large amount of power consumption of the battery 112 when power generation cannot be performed, the vehicle 110 can notify the center 130 of, for example, a signal of excessive power consumption or a signal indicating that a risk of battery rise has increased.

### Terminal

The terminal 120 is an information terminal device having a display screen 122 owned by a user or an administrator of the vehicle 110, such as a smartphone or a personal computer.

The terminal 120 has a function for realizing a remote operation service in cooperation with the vehicle 110.

The terminal 120 is communicably connected to the center 130, and performs transmission and reception of information, notifications, requests, and the like to and from the center 130. The terminal 120 can receive a notification from the center 130 regarding the fact that the vehicle 110 has stopped (prohibited) the remote operation service. In addition, the terminal 120 can send a request (such as a request for vehicle synchronization) necessary for executing the remote operation service to the center 130.

In addition, the terminal 120 includes a display control unit 121 that can perform control for displaying contents related to the remote operation service on the display screen 122. When a UI tone-down request to be described later is received from the center 130, a user interface (UI) of the remote operation service may be displayed on the display screen 122 by tone-down, or illustration of high power consumption of the vehicle 110 can be displayed on the display screen 122. At this time, when the tone-down displayed UI on the display screen 122 is touched, a message such as “unavailable due to excessive power consumption” may be displayed in the dialogue.

Typically, the terminal 120 is associated with the vehicle 110 by being registered and managed in the vehicle 110 or the center 130.

### Center

The center 130 is, for example, a so-called data center that collects and manages various data and information related to a plurality of vehicles 110.

The center 130 is communicably connected to the vehicle 110 and the terminal 120, and performs transmission/reception and relay of information, notification, requests, and the like. When the center 130 receives a notification (for example, a signal of excessive power consumption) indicating that the remote operation service has stopped from the vehicle 110, the center can manage the notification by, for example, turning ON a predetermined “excessive power consumption” flag. When a request for executing the remote operation service (a request for vehicle synchronization) is sent from the terminal 120 when the “excessive power consumption” flag is ON, the center 130 may send, to the terminal 120, a request (UI tone-down request) for causing the display screen 122 to display the stopped remote operation service in a display form different from the other vehicle services that are not stopped.

Communication between the center 130 and the vehicle 110 and communication between the center 130 and the terminal 120 are typically performed wirelessly via an external network.

### Control

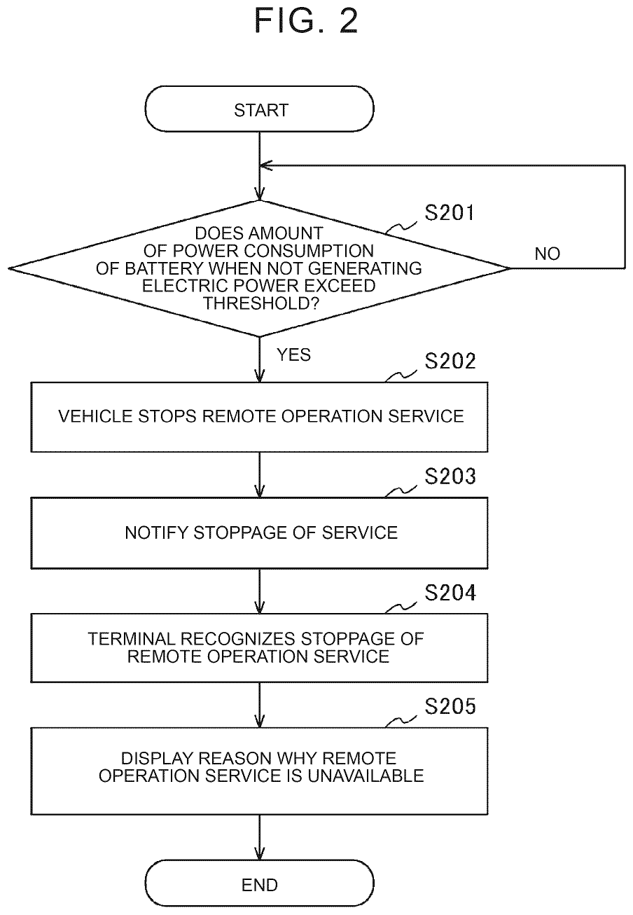

Next, an operation of the vehicle control system 100 according to an embodiment of the present disclosure will be described with further reference to FIG. 2. FIG. 2 is a flowchart for explaining a processing procedure of terminal screen display control executed by the vehicle control system 100. The terminal-screen-display control illustrated in FIG. 2 is started by, for example, ON of the ignition of the vehicle 110.

### S201

The service control unit 111 of the vehicle 110 determines whether the amount of power consumption of the battery 112 when the vehicle 110 is in a state of being unable to generate electric power (when the vehicle 110 is not generating electric power) exceeds a predetermined threshold. This determination is made to prevent the battery 112 from running out. Therefore, the predetermined threshold is set based on the capacity of the battery 112, specifications of an in-vehicle device that consumes electric power, and the like. 20 The vehicle 110 being in a state of being unable to generate electric power refers to a state in which the battery 112 is not charged, and for example, a state in which the generator cannot be operated, a state in which the solar panel power generation cannot be performed, or the like can be indicated. Whether or not the vehicle 110 can generate power and the amount of power consumption of the battery 112 can be determined based on the state of the vehicle 110 detected by various detection devices (sensors or the like) included in the vehicle 110, the physical quantity (voltage value, current value) of the battery 112, and the like.

When the service control unit 111 determines that the amount of power consumption of the battery 112 when the vehicle 110 is in a state of being unable to generate electric power (when the vehicle 110 is not generating electric) exceeds a predetermined threshold (S201, Yes), the process proceeds to S202.

On the other hand, when the service control unit 111 determines that the amount of power consumption of the battery 112 does not exceed the predetermined threshold when the vehicle 110 is in a state of being unable to generate electric power (when the vehicle 110 is not generating electric power), if the remote operation service is already stopped (prohibited) (S201, no), the remote operation service may be released and the remote operation service may be executed (permitted).

### S202

The service control unit 111 of the vehicle 110 stops (prohibits) the remote operation service. As a result, remote operation from the terminal 120 to the vehicle 110 cannot be instructed. When the service control unit 111 stops (prohibits) the remote operation service of the vehicle 110, the process proceeds to S203.

### S203

The service control unit 111 of the vehicle 110 notifies the center 130 that the remote operation service has been stopped (prohibited). This notification is performed via a communication unit (not shown). Note that the notification that the remote operation service is stopped (prohibited) may be made to the terminal 120 or may be made in parallel to the center 130 and the terminal 120. When the service control unit 111 notifies that the remote operation service of the vehicle 110 has been stopped (prohibited), the process proceeds to S204.

### S204

The display control unit 121 of the terminal 120 recognizes that the remote operation service is stopped in the vehicle 110. This recognition can be performed based on a notification that the remote operation service has been stopped, which is received from the center 130 via a communication unit (not shown). When the display control unit 121 recognizes that the remote operation service is stopped, the process proceeds to S205.

### S205

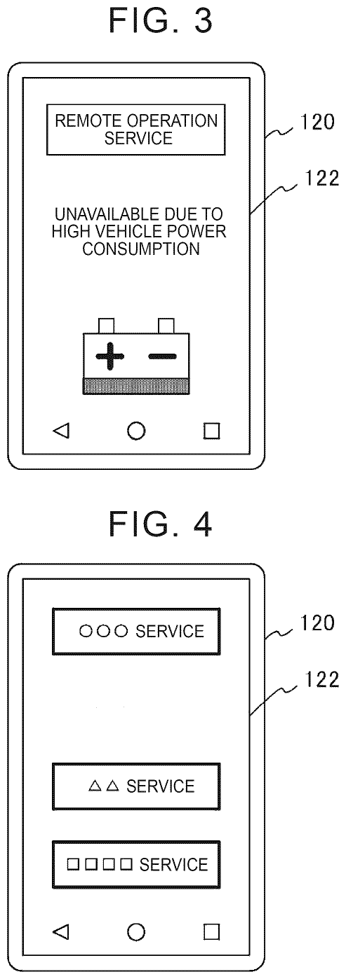

The display control unit 121 of the terminal 120 displays, on the display screen 122, the reason why the remote operation service of the vehicle 110 is unavailable from an application related to remote operation installed in the terminal 120 or the like. FIG. 3 and FIG. 4 show an example of information displayed on the display screen 122 of the terminal 120.

In FIG. 3, in the operation UI window of the remote operation service, the reason why the remote operation service is unavailable is indicated by a letter that the reason is “high power consumption of vehicles”. In addition, in the operation UI window of the remote operation service, “a large amount of electric power is consumed by the vehicle” is displayed by an illustration in which the remaining battery capacity is small.

In addition, when the terminal 120 receives a UI tone-down request from the center 130, as shown in FIG. 4, the unavailable remote operation service may be displayed on the display screen 122 in a tone-down display form (reducing the display density) that differs from other available vehicular services.

When the reason why the remote operation service is unavailable is displayed on the display screen 122 by the display control unit 121, the terminal screen display control ends.

When this S205 is completed, S201 may be returned and the terminal-screen-display control may be repeatedly performed.

### Operations and Effects

As described above, according to the vehicle control system 100 according to the embodiment of the present disclosure, when the power consumption of the battery 112 exceeds the threshold and the remote operation service is stopped when the vehicle 110 cannot generate power, a notification that the remote operation service has been stopped is sent to the terminal 120. Upon receiving the notification, the terminal 120 displays the excessive power consumption of the vehicle 110, which is a cause of the vehicle 110 stopping the remote operation service, on the display screen 122 as a reason why the remote operation service is unavailable.

By this control, the user who cannot use the remote operation service of the vehicle 110 can know the reason through the display on the display screen 122 of the terminal 120, so that it is possible to reduce the possibility of the user feeling inconvenience.

In the above embodiment, an example has been described in which information indicating that the vehicle 110 and the terminal 120 have stopped the remote operation service via the center 130 is communicated. However, the information indicating that the vehicle 110 and the terminal 120 have stopped the remote operation service may be directly communicated without passing through the center 130.

The vehicle control system of the present disclosure can be used for a vehicle having a function of a remote operation service of a vehicle using a terminal located outside the vehicle.

What is claimed is:

1. A vehicle control system that provides a remote operation service for remotely operating a device mounted on a vehicle by using a terminal located outside the vehicle, wherein:
the vehicle includes a service control unit configured to stop the remote operation service in response to an amount of power consumption of an in-vehicle battery exceeding a threshold when the vehicle is unable to generate electric power; and
the terminal includes a display control unit configured to, when the remote operation service is stopped in the vehicle, display on a display screen a reason why the remote operation service is unavailable.

2. The vehicle control system according to claim 1, wherein the display control unit is configured to display high power consumption of the vehicle on the display screen as the reason why the remote operation service is unavailable.

3. The vehicle control system according to claim 2, wherein the display control unit is configured to display the high power consumption of the vehicle by an illustration on the display screen.

4. The vehicle control system according to claim 1, wherein the display control unit is configured to display the remote operation service on the display screen in a display form different from other vehicle services that are not stopped.
